(19) United States
(12) Patent Application Publication
(10) Pub. No.: US 2026/0143034 A1
(43) Pub. Date: May 21, 2026

(54) INTERNET OF THINGS MONITORING METHOD, MONITORING MODULE GENERATION METHOD, AND ELECTRONIC APPARATUS

(71) Applicant: TATUNG UNIVERSITY, Taipei (TW)

(72) Inventors: Fu-Chiung Cheng, Taipei City (TW); Dai-Xin Wang, Taipei City (TW); Wei-Cheng Liu, New Taipei City (TW)

(73) Assignee: TATUNG UNIVERSITY, Taipei (TW)

(21) Appl. No.: 18/979,627

(22) Filed: Dec. 13, 2024

(30) Foreign Application Priority Data
Nov. 19, 2024 (TW) 113144447

(51) Int. Cl. H04L 67/125; G16Y 10/75; H04L 67/55

(52) U.S. Cl. CPC H04L 67/125; H04L 67/55; G16Y 10/75

(57) ABSTRACT

An Internet of Things (IoT) monitoring method, a monitoring module generation method, and an electronic apparatus are provided. First, a monitoring module of an IoT device is generated, including: receiving a resource description file of the IoT device; based on a resource message of each monitorable device in the resource description file, obtaining a visualization object and a control code corresponding to each monitorable device and then generating a monitoring interface; generating a control logic based on a connection message in the resource description file; generating a monitoring module based on the control logic and the monitoring interface. Then, in response to the monitoring module running in a client device, the monitoring module may be applied to monitor the IoT device via a cloud server.

### CROSS-REFERENCE TO RELATED APPLICATION

This application claims the priority benefit of Taiwan application serial no. 113144447, filed on Nov. 19, 2024. The entirety of the above-mentioned patent application is hereby incorporated by reference herein and made a part of this specification.

### BACKGROUND

### Technical Field

The disclosure relates to an Internet of Things (IoT) monitoring mechanism, and particularly to an IoT monitoring method, a monitoring module generation method, and an electronic apparatus.

### Description of Related Art

The Internet of Things (IoT) refers to a network that enables all ordinary objects capable of performing independent functions to achieve interconnection and intercommunication. Through the IoT, centralized management and control of all devices (IoT devices) in the IoT system can be realized through utilizing central control devices. However, applications or webpages for controlling the IoT devices cannot be automatically generated. Users must first understand operating modes of the IoT devices, such as data structures, communication methods, transmission content, etc. and then manually create data for the IoT devices (including sensors and actuators) on a central control device (e.g., a cloud platform). After the setup is complete, an application programming interface (API) key may be obtained. The IoT devices then use the API key provided by the cloud platform to upload data, and the transmitted data format needs to comply with the settings of the cloud platform, so as to display the data on the cloud platform.

### SUMMARY

The disclosure provides an Internet of Things (IoT) monitoring method, a monitoring module generation method, and an electronic apparatus, which may automatically construct monitoring modules corresponding to IoT devices.

According to an embodiment of the disclosure, an IoT monitoring method includes following steps. A monitoring module of an IoT device is generated through a first electronic apparatus, where the IoT device includes one or more monitorable devices, and in response to the monitoring module running on the first electronic apparatus or a second electronic apparatus, the IoT device is monitored through the monitoring module via a cloud server. Here, the step of generating the monitoring module for the IoT device through the first electronic apparatus includes: receiving a resource description file of the IoT device, where the resource description file includes a resource message corresponding to each of the one or more monitorable devices and a connection message for the IoT device to communicate with the cloud server; based on the resource message of each of the one or more monitorable devices, obtaining a visualization object and a control code corresponding to each of the one or more monitorable devices and accordingly generating a monitoring interface; generating a control logic based on the connection message; generating the monitoring module based on the control logic and the monitoring interface.

According to an embodiment of the disclosure, a monitoring module generation method for IoT execute following steps through a processor, including: receiving a resource description file of an IoT device, where the resource description file includes a resource message corresponding to each of one or more monitorable devices in the IoT device and a connection message for the IoT device to communicate with a cloud server; based on the resource message of each of the one or more monitorable devices, obtaining a visualization object and a control code corresponding to each of the one or more monitorable devices and accordingly generating a monitoring interface; generating a control logic based on the connection message; generating a monitoring module based on the control logic and the monitoring interface. Here, in response to the monitoring module running on a client device, the IoT device is monitored through the monitoring module via the cloud server.

According to an embodiment of the disclosure, an electronic apparatus includes a storage device that includes a development tool and a processor that is coupled to the storage device, where the processor is configured to execute the development tool to perform each step of the monitoring module generation method for an IoT. Here, in response to the monitoring module running on a client device, the IoT device is monitored through the monitoring module via a cloud server.

In view of the above, according to one or more embodiments of the disclosure, developers, after developing an IoT system on an IoT development platform, are allowed to directly utilize the development tool to automatically generate corresponding monitoring modules without manually inputting information of the IoT devices.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flowchart of an Internet of Things (IoT) monitoring method according to an embodiment of the disclosure.

FIG. 2 is a block diagram of a first electronic apparatus according to an embodiment of the disclosure.

FIG. 3 is a schematic diagram of generating and applying a monitoring module according to an embodiment of the disclosure.

FIG. 4 is an exemplary diagram of a resource description file according to an embodiment of the disclosure.

FIG. 5 is a schematic diagram of an editing interface according to an embodiment of the disclosure.

FIG. 6A is a schematic diagram of an initial screen according to an embodiment of the disclosure.

FIG. 6B is a schematic diagram of a preview screen according to an embodiment of the disclosure.

FIG. 7A is a schematic diagram of an editing screen according to an embodiment of the disclosure.

FIG. 7B is a schematic diagram of a preview screen according to an embodiment of the disclosure.

FIG. 8A is a schematic diagram of an editing screen according to an embodiment of the disclosure. FIG. 8B is a schematic diagram of a preview screen according to an embodiment of the disclosure.

FIG. 9 is a flowchart of a monitoring method according to an embodiment of the disclosure.

### DESCRIPTION OF THE EMBODIMENTS

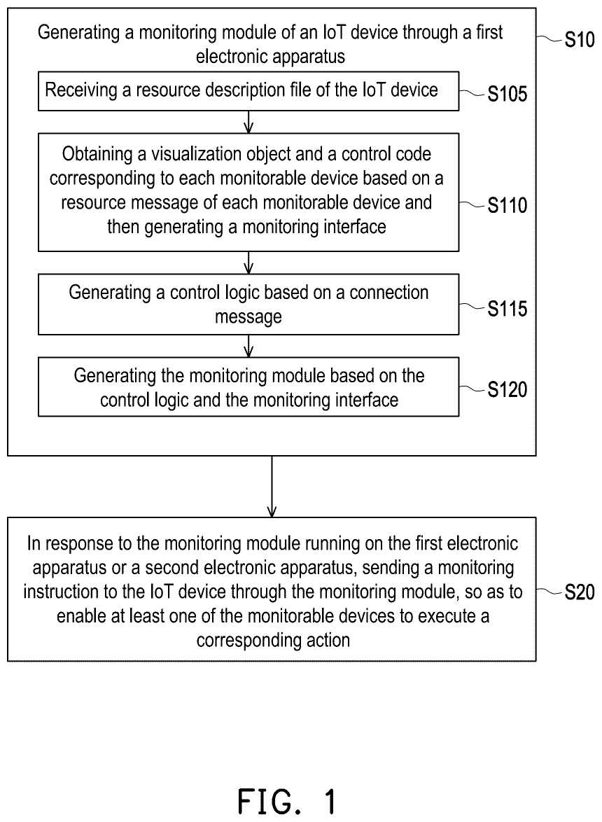

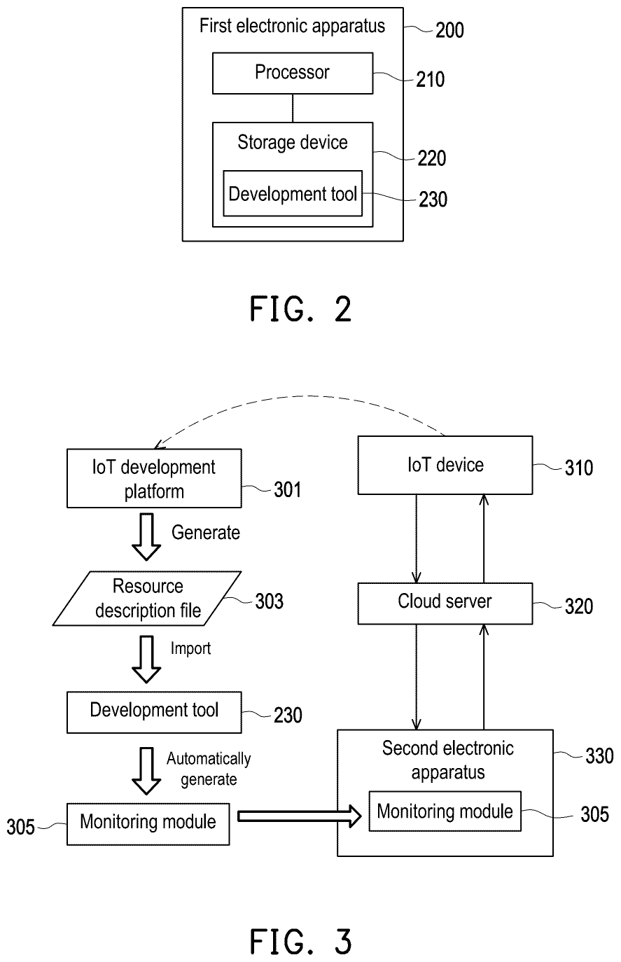

FIG. 1 is a flowchart of an Internet of Things (IoT) monitoring method according to an embodiment of the disclosure. FIG. 2 is a block diagram of a first electronic apparatus according to an embodiment of the disclosure. FIG. 3 is a schematic diagram of generating and applying a monitoring module according to an embodiment of the disclosure.

With reference to FIG. 1, FIG. 2, and FIG. 3, in step S10, a monitoring module 305 of an IoT device 310 is generated through a first electronic apparatus 200, where the IoT device 310 includes one or more monitorable devices. The monitorable devices may be sensors or actuators. The sensors are, for instance, temperature sensors, humidity sensors, acceleration sensors, image sensors, electric current sensors, pressure sensors, infrared sensors, and so on. The actuators are, for instance, power switches, drivers for electronic elements, motors, valve actuators, and so on. The monitoring module 305 is, for instance, an application (APP) or a webpage that may be used to monitor the IoT device 310.

The first electronic apparatus 200 includes a processor 210 and a storage device 220 that is coupled to the processor 210. The processor 210 may be implemented in the form of a central processing unit (CPU), a physics processing unit (PPU), a programmable microprocessor, an embedded control chip, a digital signal processor (DSP), an application specific integrated circuits (ASIC), or any other similar device.

The storage device 220 may be implemented in the form of any type of fixed or movable random access memory (RAM), read-only memory (ROM), flash memory, hard disk, any other similar device, or a combination of these devices. In this embodiment, the storage device 220 includes a development tool 230, which, when installed, is executed by the processor 210 to perform the aforementioned step S10.

After the monitoring module 305 is generated, in step S20, in response to the monitoring module 305 running on the first electronic apparatus 200 or a second electronic apparatus 330 (different from the first electronic apparatus 200), the IoT device 310 is monitored through the monitoring module 305 via a cloud server 320. In one embodiment of the disclosure, the monitoring module 305 may be executed by the first electronic apparatus 200. In another embodiment of the disclosure, the monitoring module 305 may also be provided to the second electronic apparatus 330, which is different from the first electronic apparatus 200, so as to execute the monitoring module 305 through the second electronic apparatus 330.

After the monitoring module 305 is generated, the first electronic apparatus 200 may further bind the monitoring module 305 to a specified group according to the content of the resource description file. For instance, if it is assumed that the location of the IoT device 310 is City A, the resource description file further records a group message related to City A, thereby enabling the first electronic apparatus 200 to bind the generated monitoring module 305 to the specified group.

In one embodiment of the disclosure, the monitoring module 305 is an application (APP) that can be installed and run on client devices, such as smartphones, personal computers, mobile computers, and so forth (which can be the first electronic apparatus 200, the second electronic apparatus 330, or any other electronic apparatus with computing capabilities). In another embodiment of the disclosure, the monitoring module 305 is a webpage provided to a web server, and the client devices connect the web server to use the webpage and thereby monitor the IoT device 310 through operations on the webpage.

In one embodiment of the disclosure, multiple monitoring modules 305 (e.g., installing multiple APPs) may simultaneously run on the client device (which may be the first electronic apparatus 200 or the second electronic apparatus 330), and these monitoring modules are respectively configured to control the IoT devices arranged in different regions.

Additionally, multiple monitoring modules can be grouped according to their locations. For instance, if it is assumed that a company has established Plant A in City A and Plant B in City B, the monitoring modules corresponding to the IoT devices included in Plant A can be set as Group A, while the monitoring modules corresponding to the IoT devices included in Plant B can be set as Group B. The monitoring modules in Groups A and B may be configured on the same client device for use.

Specifically, step S10 includes steps S105 to S120. In step S105, the development tool 230 receives a resource description file 303 of the IoT device 310. Here, the resource description file 303 includes a resource message corresponding to each monitorable device of the IoT device 310 and a connection message for the IoT device 310 to communicate with the cloud server 320. The resource description file 303 may be, for instance, a JavaScript Object Notation (JSON) file.

In the embodiment depicted in FIG. 3, the resource description file 303 of the IoT device 310 is generated through an IoT development platform 301 (a tool for developing IoT systems). The IoT development platform 301 may run on the first electronic apparatus 200 and includes building block elements related to the IoT device 310. Developers can utilize these building block elements to develop the IoT systems and accordingly generate the resource description files. After the resource description file 303 is generated, the resource description file 303 is imported into the development tool 230.

In one embodiment of the disclosure, the IoT development platform 301 may be, for instance, a Snap!IoT tool (with reference to https://iot.ttu.edu.tw/Snap9uPythonPicoW/SnapPlus.html), which should however not be construed as a limitation but an exemplary embodiment in the disclosure.

Additionally, the IoT development platform 301 may also run on another electronic apparatus different from the first electronic apparatus 200. After the resource description file 303 is generated, the resource description file 303 can be provided to the first electronic apparatus 200 by applying wired or wireless communication protocols. Moreover, the resource description file 303 can also be directly edited by applying a predefined template, and it is not necessary to automatically generate the resource description file 303 through the IoT development platform 301.

In one embodiment of the disclosure, the resource description file 303 includes a unique identifier, a category identifier, a device identifier, a resource list, a resource message corresponding to each monitorable device, and account information (user account, password) for accessing the cloud server 320. The unique identifier may be, for instance, a media access control (MAC) address of a Wi-Fi module or the MAC address of a Bluetooth module of the IoT device 310. The category identifier is configured to indicate whether the IoT device 310 belongs to categories such as smart home, smart plant, or smart healthcare applications. The device identifier may be, for instance, the identifier of the IoT device 310. The IoT device 310 is, for instance, a refrigerator, light, a temperature and humidity meter, an electric fan, a robot vacuum cleaner, and so forth.

The resource list records descriptions of one or more sensors and/or one or more actuators included in the IoT device 310. The descriptions of the resource message for the sensors and the actuators are referred to as those provided in the Internet Protocol for Smart Objects (IPSO) standard and/or the Smart Appliance Alliance Network (SAANET) standard. Each resource message describes configuration parameter content of each monitorable device.

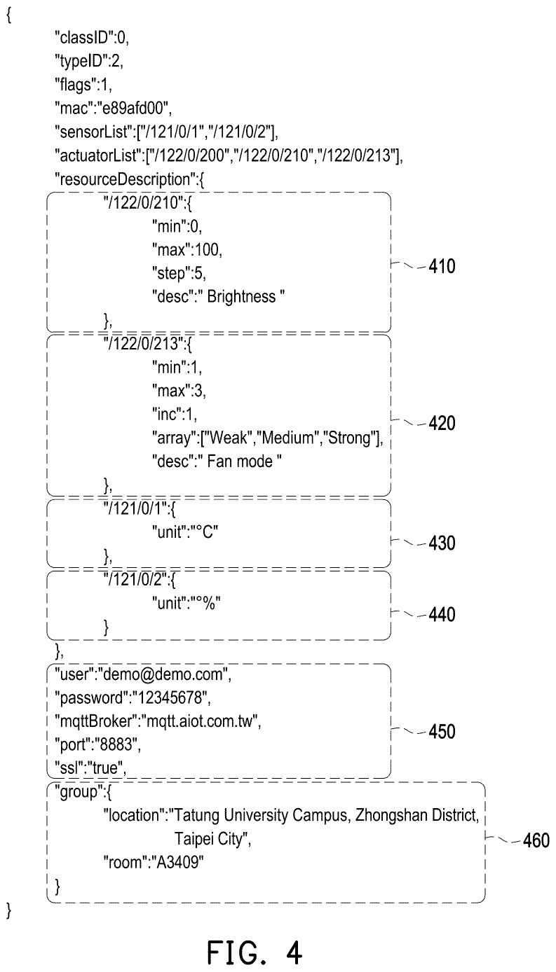

FIG. 4 is an exemplary diagram of a resource description file according to an embodiment of the disclosure. FIG. 4 shows one embodiment of the resource description file 303 of the IoT device 310. With reference to FIG. 4, a variable “classID” represents the category identifier, which serves to indicate whether the IoT device 310 belongs to categories such as smart home, smart healthcare, or smart plant. For instance, when the value of the variable “classID” is 0, it indicates that the IoT device 310 belongs to the smart home category; when the value of the variable “classID” is 1, it indicates that the IoT device 310 belongs to the smart healthcare category; when the value of the variable “classID” is 2, it indicates that the IoT device 310 belongs to the smart plant category.

A variable “typeID” represents the identifier of the IoT device 310. With reference to Table 1, it shows various IoT devices and their corresponding identifiers “typeID”. For instance, when the value of the variable “typeID” is 1, it indicates that this IoT device 310 is an air conditioner; when the value of the variable “typeID” is 2, it indicates that this IoT device 310 is a refrigerator; when the value of the variable “typeID” is 3, it indicates that this IoT device 310 is a washing machine, and so on.

TABLE 1

| IoT device | typeID |
|---|---|
| Air conditioner | 1 |
| Refrigerator | 2 |
| Washing machine | 3 |
| . . . | . . . |
| Smart socket | 100 |
| . . . | . . . |

A variable “flags” indicates whether the IoT device 310 can be turned off. When the value of the variable “flags” is 1, it represents that the IoT device 310 cannot be turned off in a power-saving mode; when the value of the variable “flags” is 0, it represents that the IoT device 310 can be turned off in the power-saving mode.

A variable “mac” represents the unique identifier of the IoT device 310.

A variable “sensorList” represents a sensor list, indicating the descriptions of the sensors (a variable “deviceID” is “121”) included in the IoT device 310. Here, the sensor list includes “/121/0/1” and “/121/0/2” with the description format as {deviceID}/{number}/{resourceID}. A variable “actuatorList” represents an actuator list, indicating the descriptions of the actuators (the variable “deviceID” is “122”) included in the IoT device 310. Here, the actuator list includes “/122/0/200”, “/122/0/210”, and “/122/0/213” with the description format as {deviceID}/{number}/{resourceID}.

The variable “deviceID” represents the identifier of the monitorable device (the sensor, the actuator). With reference to Table 2, it shows various monitorable devices and their corresponding identifiers “deviceID”. For instance, when the value of the variable “deviceID” is 120, it indicates that the monitorable device is integrated with both the sensor and the actuator; when the value of the variable “deviceID” is 121, it indicates that the monitorable device is a sensor; when the value of the variable “deviceID” is 122, it indicates that the monitorable device is an actuator. The rest can be deduced therefrom.

TABLE 2

| Monitorable device | deviceID |
|---|---|
| Sensor and actuator | 120 |
| Sensor | 121 |
| Actuator | 122 |
| Temperature and humidity meter | 124 |
| Wind gauge | 125 |
| Checklist | 126 |
| Drip detection | 127 |
| Alarm | 128 |
| Air quality sensor | 129 |
| Carbon dioxide sensor | 130 |
| Carbon monoxide sensor | 131 |
| Blood pressure monitor | 132 |
| Height/weight scale | 133 |
| Weight scale | 134 |
| Kidney dialysis machine | 135 |

A variable “number” represents the ordinal number of the monitorable device. For the temperature sensors, when the value of the variable “number” is “0”, it represents the first temperature sensor; when the value of the variable “number” is “1”, it represents the second temperature sensor, and so on.

A variable “resourceID” represents the type of the monitorable devices, and different monitorable devices have different resourceID lists. For instance, Table 3 shows the resourceID list corresponding to the type of the sensors, and Table 4 shows the resourceID list corresponding to the type of the actuators.

With reference to Table 3, when the value of the variable “resourceID” is “1”, it represents that the sensor is of a temperature sensor type; when the value of the variable “resourceID” is “2”, it represents that the sensor is of a humidity sensor type; when the value of the variable “resourceID” is “3”, it represents that the sensor is of a light meter type, and so on.

TABLE 3

| Types of the monitorable devices | |
|---|---|
| (Types of the sensors) | resourceID |
| Temperature sensor | 1 |
| Humidity sensor | 2 |
| Light sensor | 3 |
| Magnetic sensor | 4 |
| Color sensor | 5 |
| . . . | . . . |

With reference to Table 4, when the value of the variable “resourceID” is “200”, it represents that the actuator type is of a switch type; when the value of the variable “resourceID” is “201”, it represents that the actuator is of a light-emitting diode (LED) type, and so on.

TABLE 4

| Types of the monitorable devices | |
|---|---|
| (Type of the actuators) | resourceID |
| Switch | 200 |
| LED | 201 |
| Buzzer | 202 |
| Start | 203 |
| Play | 204 |
| Stop | 205 |
| Fast forward | 206 |
| Reverse | 207 |
| Previous song/step/page | 208 |
| Next song/step/page | 209 |
| Value | 210 |
| Time | 211 |
| Time scheduling | 212 |
| Mode switching | 213 |
| . . . | . . . |

The relevant descriptions of each monitorable device may be referred to as the descriptions in a variable “resourceDescription”. The variable “resourceDescription” serves to further describe the detailed settings of the resource message. A programming code block 410 records the detailed description of “/122/0/210”, where the variable deviceID=122 represents that the monitorable device is an actuator (as shown in Table 2), the variable resourceID=210 represents that the type of the actuator is an adjustable value (as shown in Table 4), variables “min” and “max” represent that the adjustable value range is 0 to 100, a variable “step” represents that each adjustment increment is 5, and a variable “desc” represents that the adjustable parameter is brightness.

A programming code block 420 records the detailed description of “/122/0/213”, where the variable deviceID=122 represents that the monitorable device is an actuator (as shown in Table 2), the variable resourceID=213 represents that the actuator is of a mode switching type (as shown in Table 4), the variables “min” and “max” represent that the minimum mode switching is 1 and the maximum is 3, respectively, a variable “inc” represents that each mode switching is incremented or decremented by 1 (i.e., including three modes 1, 2, 3), a variable “array” represents three switchable modes, namely, strong, medium, and weak, and the variable “desc” represents that the switched mode is a fan mode.

A programming code block 430 records the detailed description of “/121/0/1”, where the variable deviceID=121 represents that the monitorable device is a sensor (refer to Table 2), the variable resourceID=1 represents that the sensor type is a temperature sensor (refer to Table 3), and the variable “unit” represents the unit of the value measured by the temperature sensor.

A programming code block 440 records the detailed description of “/121/0/2”, where the variable deviceID=121 represents that the monitorable device is a sensor (as shown in Table 2), the variable resourceID=2 represents that the sensor is of a humidity sensor type (as shown in Table 3), and a variable “unit” represents the unit of the value measured by the humidity sensor.

A programming code block 450 records the detailed description of the connection message, where the variables “user” and “password” represent the user account and the password used to access the cloud server 320, respectively, a variable “mqttBroker” is the internet protocol address (IP address) of the cloud server 320, a variable “port” is the port number of the cloud server 320, and a variable “ssl” represents whether the cloud server 320 has a transport layer security protocol.

A programming code block 460 serves to record the group message of this IoT device 310.

After the resource description file 303 is imported into the development tool 230, in step S110, the development tool 230 obtains a visualization object and a control code corresponding to each monitorable device based on the resource message of each monitorable device (referring to the programming code blocks 410 to 440) and then generates a monitoring interface. The development tool 230 may automatically generate the corresponding visualization object and control code according to the IPSO standard of the IoT device 310 and then generate the monitoring module based on the visualization object and the control codes. In one embodiment of the disclosure, the development tool 230 includes multiple preset visualization objects and multiple control codes. The development tool 230 may directly utilize the default content in the preset sample pages to generate the monitoring interface or modify and adjust the default content in the sample pages to re-design the monitoring interface. In step S115, the development tool 230 generates the control logic based on the connection message (referring to the programming code block 450). The connection message includes the IP address of the cloud server 320 and the user account and the password used to access the cloud server 320. The development tool 230 automatically generates the control logic according to the connection message and the resource message in the resource description file 303. The control logic serves to establish a connection with the cloud server 320 and associate with one or more topics provided by the cloud server 320, e.g., subscribing to the topic corresponding to the resource message of this IoT device 310 from the cloud server 320.

In one embodiment of the disclosure, the cloud server 320 is, for instance, a server (such as a message broker) that adopts the message queuing telemetry transport (MQTT) protocol. The MQTT protocol is an information transmission protocol based on a publication/subscription mechanism. The transmission of information is managed through topics.

Next, in step S120, the development tool 230 generates the monitoring module 305 based on the control logic and the monitoring interface. The monitoring module 305 further provides the function of permission control. For instance, the monitoring module 305 may share all or part of the control permissions of the IoT device 310 to other users.

In one embodiment of the disclosure, the development tool 230 may arrange the visualization objects to be at the default positions in the sample page and associate the visualization objects with the control codes, thereby generating the monitoring interface.

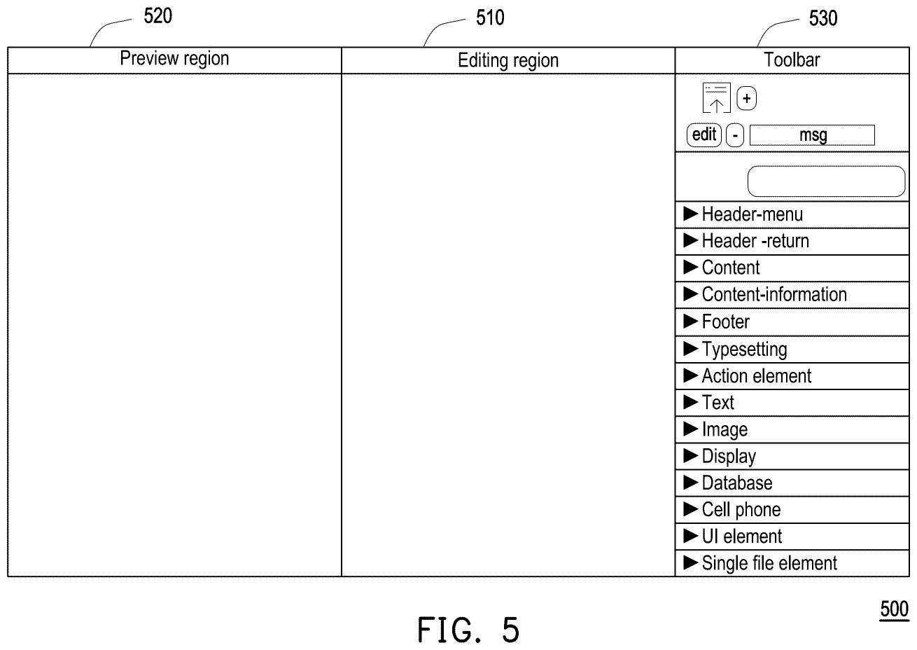

In one embodiment of the disclosure, the development tool 230 provides an editing interface for the user of the first electronic apparatus 200 to edit the monitoring interface. FIG. 5 is a schematic diagram of an editing interface according to an embodiment of the disclosure. With reference to FIG. 5, an editing interface 500 includes an editing region 510, a preview region 520, and a toolbar 530. The editing region 510 serves to edit the display content of the monitoring interface. The preview region 520 serves to present a preview screen of the current editing content in the editing region 510. The toolbar 530 provides various editing functions. The development tool 230 first arrange the visualization objects to the default positions in the editing region 510, then adjusts the positions of the visualization objects based on user operations, and associates the visualization objects with the control codes, thereby generating the monitoring interface.

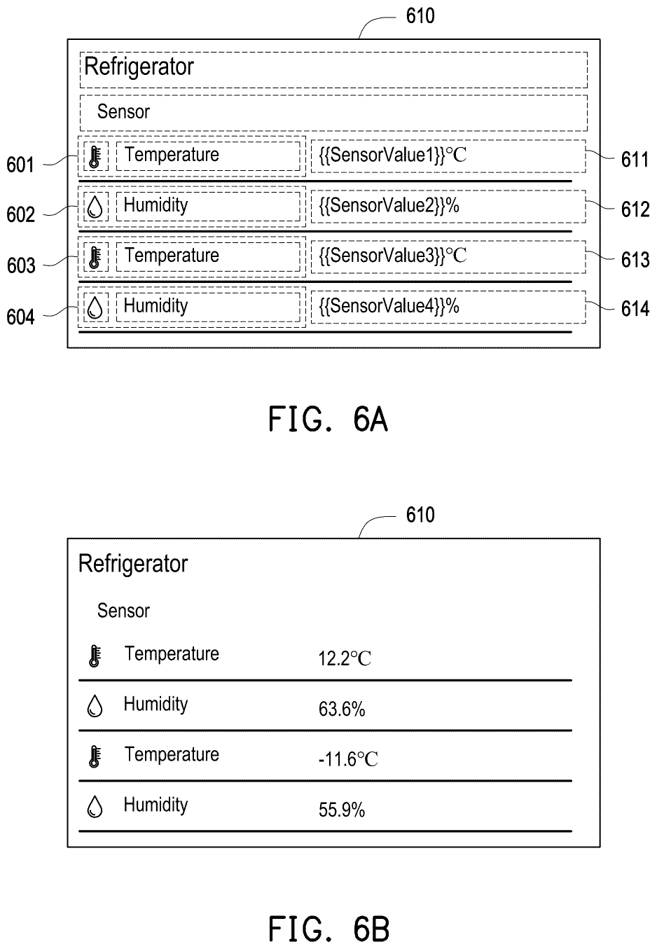

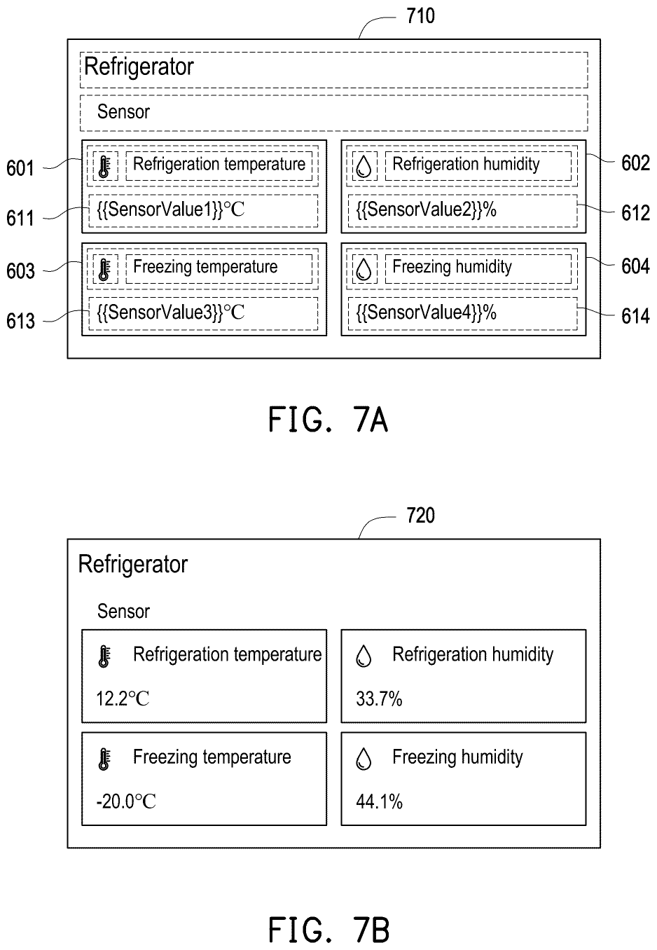

FIG. 6A is a schematic diagram of an initial screen according to an embodiment of the disclosure. FIG. 6B is a schematic diagram of a preview screen according to an embodiment of the disclosure. FIG. 6A illustrates an initial screen 610 in the editing region 510, and FIG. 6B illustrates a preview screen 620 corresponding to the initial screen 610.

In this embodiment, the IoT device 310 is, for instance, a refrigerator (typeID=2), which has a first temperature sensor (e.g., described as “/121/0/1”) and a first humidity sensor (e.g., described as “/121/0/2”) installed in the refrigerator compartment and a second temperature sensor (e.g., described as “/121/1/1”) and a second humidity sensor (e.g., described as “/121/1/2”) installed in the freezer compartment. After the resource description file 303 of the IoT device 310 (the refrigerator) is imported into the development tool 230, the development tool 230 can recognize that the IoT device 310 includes two temperature sensors and two humidity sensors and subsequently obtain the visualization objects 601 to 604 corresponding to the first temperature sensor, the first humidity sensor, the second temperature sensor, and the second humidity sensor, as well as message boxes 611 to 614 (for associating with the corresponding control codes). Here, the visualization objects 601 to 604 are associated with the message boxes 611 to 614, respectively. In the message boxes 611 to 614, the values obtained from the first temperature sensor, the first humidity sensor, the second temperature sensor, and the second humidity sensor of the IoT device 310 are read through the corresponding control codes.

Moreover, the development tool 230 retrieves the sample page corresponding to the refrigerator and arrange the visualization objects 601 to 604 and the message boxes 611 to 614 in their respective positions. Each of the visualization objects 601 to 604 includes an icon and a text description. After the arrangement is complete, the preview screen 620 as shown in FIG. 6B can be obtained through the preview function of the development tool 230.

FIG. 7A is a schematic diagram of an editing screen according to an embodiment of the disclosure. FIG. 7B is a schematic diagram of a preview screen according to an embodiment of the disclosure. FIG. 7A illustrates an editing screen 710 obtained after the initial screen 610 depicted in FIG. 6A is edited, and FIG. 7B illustrates a preview screen 720 corresponding to the editing screen 710. For instance, the user may drag and drop the visualization objects 601 to 604 and their associated message boxes 611 to 614 in the editing region 510. After the editing is complete, the preview screen 720 as shown in FIG. 7B may be obtained through the preview function of the development tool 230.

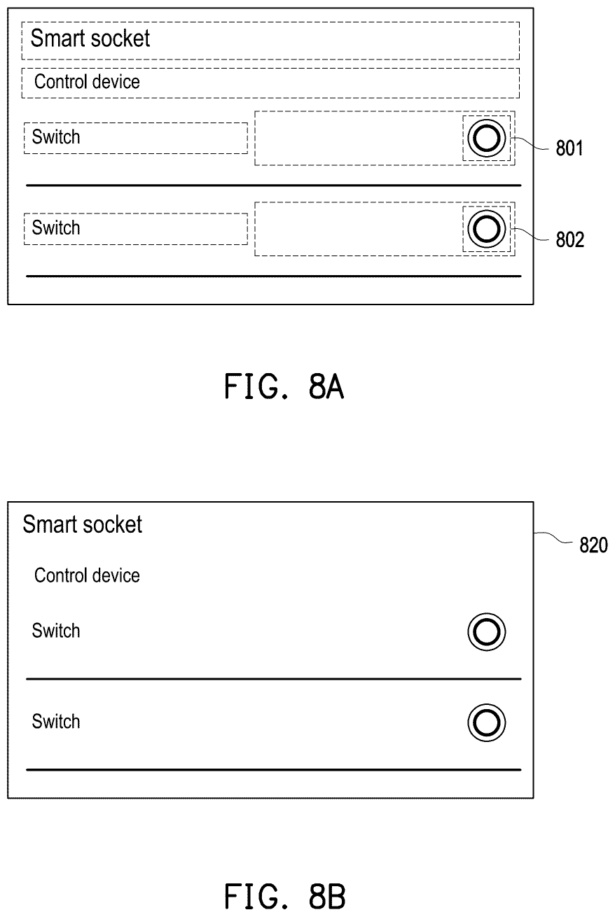

FIG. 8A is a schematic diagram of an editing screen according to an embodiment of the disclosure. FIG. 8B is a schematic diagram of a preview screen according to an embodiment of the disclosure. In this embodiment, the IoT device 310 is, for instance, a smart socket (typeID=100), which includes two switches (e.g., described as “/122/0/200”, “/122/1/200”). After the resource description file 303 of the IoT device 310 (the smart socket) is imported into the development tool 230, the development tool 230 can recognize that the IoT device 310 includes two switches and subsequently obtain visualization objects 801 and 802 corresponding to the two switches, and the development tool 230 can associate the control codes corresponding to the two switches with the visualization objects 801 and 802, respectively. After the configuration is complete, the preview screen 820 as shown in FIG. 8B may be obtained through the preview function of the development tool 230.

The development tool 230 may import one resource description file at a time or import multiple resource description files simultaneously, which should not be construed as a limitation in the disclosure.

In the case where the monitoring module 305 runs on a client device (which may be the first electronic apparatus 200 or the second electronic apparatus 330) or a web server, the client device (or the web server) connects the cloud server 320 based on the control logic of the monitoring module 305 and establishes associations with one or more topics provided by the cloud server 320. Subsequently, the client device displays the monitoring interface provided by the monitoring module 305 to perform one of the following steps through the monitoring interface. In response to a first topic of all the topics included in the cloud server 320 that is associated with the monitoring module 305 receiving a publication message and receiving the publication message from the cloud server 320, the publication message is presented in the monitoring interface. In response to the monitoring interface receiving a monitoring instruction corresponding to a visualization object, the monitoring instruction is published to a second topic corresponding to the visualization object in the cloud server 320, and subsequently the monitoring instruction is published to the IoT device 310 via the cloud server 320, so as to enable at least one monitorable device to execute the corresponding action. For instance, the processor of the IoT device 310 may drive the light (the monitorable device) to turn on or off according to the monitoring instruction, adjust a rotation speed of the motor (the monitorable device) according to the monitoring instruction, or the like.

In an embodiment, the cloud server 320 adopts the MQTT message broker, and the cloud server 320 provides multiple topics. A publisher publishes messages related to one of the topics, and a subscriber may receive relevant messages by subscribing to this topic. When a publisher publishes a new message, the cloud server 320 (the intermediary) forwards that message to all subscribers who have subscribed to that topic. The subscribers may receive different messages by subscribing to different topics and may also stop receiving relevant messages by unsubscribing from a certain topic.

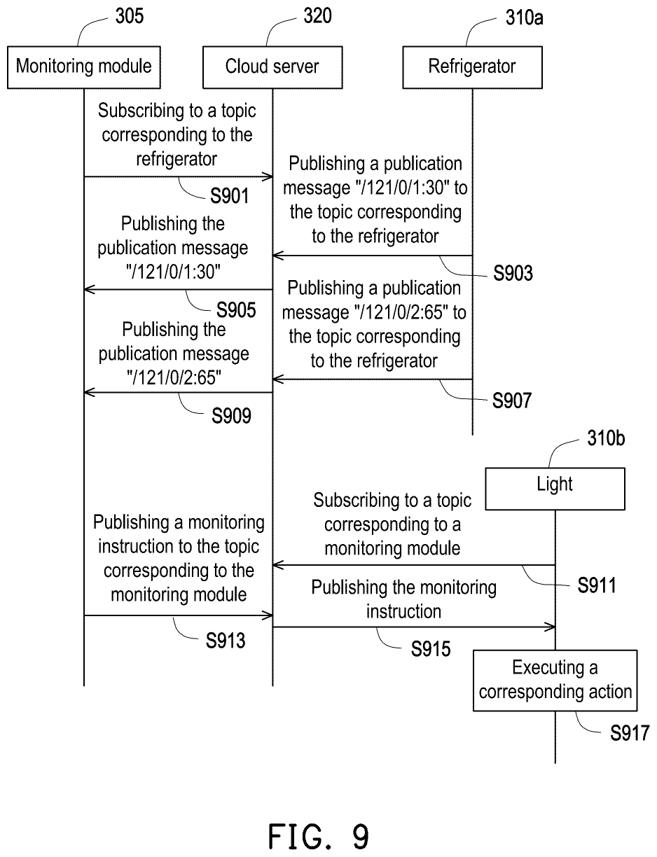

FIG. 9 is a flowchart of a monitoring method according to an embodiment of the disclosure. In this embodiment, the cloud server 320 adopts the MQTT message broker. The monitoring module 305 is arranged in a client device (the first electronic apparatus 200 or the second electronic apparatus 330) or a web server, and the refrigerator 310a and the light 310b are IoT devices, which should however not be construed as a limitation in this disclosure. In the MQTT protocol architecture, both the client device and the IoT devices may act as the subscribers and the publishers.

With reference to FIG. 9, in step S901, the client device subscribes to the topic corresponding to the refrigerator 310a through the monitoring module 305 to the cloud server 320. In step S903, the refrigerator 310a publishes a publication message “/121/0/1:30” to the topic corresponding to the refrigerator 310a in the cloud server 320, which represents that the temperature of the first thermometer of the refrigerator 310a is 30° C. In step S905, the cloud server 320 publishes the publication message “/121/0/1:30” to all subscriber devices that have subscribed to the topic corresponding to the refrigerator 310a. After the publication message “/121/0/1:30” is received, the monitoring module 305 displays “30° C.” in the message box corresponding to the description “/121/0/1” in its monitoring interface.

In step S907, the refrigerator 310a publishes a publication message “/121/0/2:65” to the topic corresponding to the refrigerator 310a in the cloud server 320, which represents that the humidity of the first hygrometer of the refrigerator 310a is 65%. In step S909, the cloud server 320 publishes the publication message “/121/0/2:65” to all subscriber devices that have subscribed to the topic corresponding to the refrigerator 310a. After the publication message “/121/0/2:65” is received, the monitoring module 305 displays “65%” in the message box corresponding to the description “/121/0/2” in its monitoring interface.

Additionally, in step S911, the light 310b may also subscribe to the topic corresponding to the monitoring module 305 in the cloud server 320. In step S913, when a visualization object (e.g., a “switch object”) is triggered in the monitoring interface provided by the monitoring module 305 on the client device, the monitoring module 305 publishes a monitoring instruction (such as a turn-on instruction or a turn-off instruction) to the topic corresponding to the monitoring module 305 in the cloud server 320. In step S915, the cloud server 320 publishes the monitoring instruction to all subscriber devices that have subscribed to the topic corresponding to the monitoring module 305. In step S917, the light 310b executes the action corresponding to the monitoring instruction. For instance, the publishing device may be a smartphone that publishes a monitoring instruction “turn on the light” and publishes this monitoring instruction to the topic corresponding to the monitoring module 305 in the cloud server 320.

To sum up, one or more embodiments of the disclosure provide a method for integrating the electronic apparatus, the cloud server, and the IoT devices, and a no-code cross-application and webpage development tool is applied to construct the monitoring module. Accordingly, after developers complete the development of an IT system on the IoT development platform, the developers can directly utilize the development tool to automatically generate the corresponding monitoring module without manually inputting information of the IoT devices.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An Internet of Things monitoring method, comprising:
generating a monitoring module of an Internet of Things device through a first electronic apparatus, wherein the Internet of Things device comprises one or more monitorable devices; and
in response to the monitoring module running on the first electronic apparatus or a second electronic apparatus, monitoring the Internet of Things device through the monitoring module via a cloud server,
wherein the step of generating the monitoring module of the Internet of Things device through the first electronic apparatus comprises:
receiving a resource description file of the Internet of Things device, wherein the resource description file comprises a resource message respectively corresponding to each of the one or more monitorable devices and a connection message for the Internet of Things device to communicate with the cloud server;
based on the resource message of each of the one or more monitorable devices, obtaining a visualization object and a control code corresponding to each of the one or more monitorable devices and accordingly generating a monitoring interface;
generating a control logic based on the connection message; and
generating the monitoring module based on the control logic and the monitoring interface.

2. The Internet of Things monitoring method according to claim 1, wherein the step of generating the monitoring module of the Internet of Things device through the first electronic apparatus further comprises:
arranging the visualization object to be at a preset position in a sample page, associating the visualization object with the control code, and accordingly generating the monitoring interface.

3. The Internet of Things monitoring method according to claim 1, wherein the first electronic apparatus has a development tool, the development tool provides an editing region, and the step of generating the monitoring module of the Internet of Things device through the first electronic apparatus further comprises:
arranging the visualization object to be at a preset position in the editing region; and
in the editing region, adjusting the position of the visualization object based on a user operation, associating the visualization object with the control code, and accordingly generating the monitoring interface.

4. The Internet of Things monitoring method according to claim 1, wherein in response to the monitoring module running in the first electronic apparatus or the second electronic apparatus, the Internet of Things monitoring method further comprises:
accessing the cloud server based on the control logic of the monitoring module and establishing associations with one or more topics provided by the cloud server;
displaying the monitoring interface provided by the monitoring module to realize one of following steps through the monitoring interface, comprising:
in response to a first topic of the one or more associated topics in the cloud server receiving a publication message and receiving the publication message from the cloud server, presenting the publication message in the monitoring interface; and
in response to the monitoring interface receiving a monitoring instruction corresponding to the visualization object, publishing a monitoring instruction to a second topic of the one or more topics in the cloud server corresponding to the visualization object and accordingly publishing the monitoring instruction to the Internet of Things device via the cloud server, so as to enable at least one of the one or more monitorable devices to execute a corresponding action.

5. The Internet of Things monitoring method according to claim 1, further comprising:
generating the resource description file of the Internet of Things device through an Internet of Things development platform.

6. The Internet of Things monitoring method according to claim 1, wherein the resource description file comprises: a unique identifier, a category identifier, a device identifier, a resource list, the resource message corresponding to each of the one or more monitorable devices, and account information for accessing the cloud server.

7. The Internet of Things monitoring method according to claim 1, wherein the monitoring module is an application or a webpage.

8. The Internet of Things monitoring method according to claim 1, wherein after generating the monitoring module, further comprising:
binding the monitoring module to a group.

9. A monitoring module generation method for Internet of Things, performing following steps through a processor, comprising:
receiving a resource description file of an Internet of Things device, wherein the resource description file comprises a resource message respectively corresponding to one or more monitorable devices in the Internet of Things device and a connection message for the Internet of Things device to communicate with a cloud server;
based on the resource message of each of the one or more monitorable devices, obtaining a visualization object and a control code corresponding to each of the one or more monitorable devices and accordingly generating a monitoring interface;
generating a control logic based on the connection message; and
generating a monitoring module based on the control logic and the monitoring interface,
wherein in response to the monitoring module running in a client device, the Internet of Things device is monitored through the monitoring module via the cloud server.

10. An electronic apparatus, comprising:
a storage device, comprising a development tool; and
a processor, coupled to the storage device, wherein the processor is configured to execute the development tool to:
receive a resource description file of an Internet of Things device, wherein the resource description file comprises a resource message respectively corresponding to one or more monitorable devices in the Internet of Things device and a connection message for the Internet of Things device to communicate with a cloud server;
based on the resource message of each of the one or more monitorable devices, obtain a visualization object and a control code corresponding to each of the one or more monitorable devices and accordingly generate a monitoring interface;
generate a control logic based on the connection message; and
generate a monitoring module based on the control logic and the monitoring interface,
wherein in response to the monitoring module running in a client device, the Internet of Things device is monitored through the monitoring module via the cloud server.
